(19) United States
(12) Patent Application Publication
(10) Pub. No.: US 2026/0131503 A1
(43) Pub. Date: May 14, 2026

(54) METHOD FOR MANUFACTURING A TILE PRODUCT

(71) Applicant: Benelux Applied Surfaces, LLC, Archbald, PA (US)

(72) Inventors: David W. Lewis, Shavertown, PA (US); Nathan J. Keisling, Dalton, PA (US); Victoria M. Frosini, Dalton, PA (US)

(21) Appl. No.: 19/404,189

(22) Filed: Dec. 1, 2025

Related U.S. Application Data
(63) Continuation-in-part of application No. 18/830,133, filed on Sep. 10, 2024, now Pat. No. 12,485,578.
(60) Provisional application No. 63/644,902, filed on May 9, 2024.

(51) Int. Cl. B28B 19/00; B28B 3/02; B28B 13/02

(52) U.S. Cl. CPC B28B 19/0053; B28B 3/022; B28B 13/02

(57) ABSTRACT

A method and system for manufacturing a tile product includes applying a concrete mixture to a mold, providing an adhesive to improve adhesion between the tile and the concrete mixture, facing a first side of the tile toward the concrete mixture in the mold and positioning the first side of the tile on the concrete mixture in the mold and then removing the product from the mold.

### CROSS REFERENCE TO RELATED APPLICATIONS

The present application is a continuation-in-part of U.S. patent application Ser. No. 18/830,133, filed Sep. 10, 2024 (NOR05 P101A), which claims the benefit of U.S. Prov. App. Ser. No. 63/644,902, filed May 9, 2024 (NOR05 P101 ), which are incorporated herein by reference in their entireties.

### TECHNICAL FIELD AND BACKGROUND

The present disclosure relates to forming a landscaping tile product that looks like a ceramic tile, or another type of tile or tile-like component, but without the attendant issues associated with using tiles in landscaping.

Tile, especially ceramic tile, is relatively brittle and, hence, can easily fracture when not properly supported. More recently, ceramic tiles have been inserted into molds followed by a concrete backing to stabilize and increase the strength of ceramic tile so that it can then be incorporated as a landscaping product without the attendant risks of damage when using tile alone. While this finished product exhibits increased strength and resistance to breaking, in some cases the process may apply too much stress on the ceramic tile so that the ceramic tile breakage in the manufacturing process may exceed desired levels and cause waste in the manufacturing process.

In other applications, the tile may be post applied to a concrete base. While the concrete base may provide support to the tile, alignment of the tile with the concrete base may not be sufficiently precise and delamination may occur.

### SUMMARY

The present disclosure relates to a method and system for manufacturing a tile product from a tile and a concrete base.

The method includes feeding a concrete mixture into a mold cavity. The method further placing or positioning a tile on the concrete mixture in the mold cavity, with its first side contacting the concrete mixture in the mold cavity. The method further includes providing an adhesive to improve the adhesion between the tile and the concrete mixture. Thereafter, the tile and concrete mixture assembly is removed from the mold cavity.

Optionally, pressure and/or vibration may be applied to the concrete mixture (before placing the tile on the concrete mixture) to densify the concrete mixture.

Optionally, pressure and/or vibration may be applied before and/or after the tile is

positioned on the concrete mixture.

When pressure is applied before positioning the tile on the concrete mixture, the applied pressure may be much higher than if applied after the tile is placed in the mold. For example, the pressure applied to the concrete mixture when applied before the tile is positioned on the concrete mixture may be up to 100 bar. When applied after the positioning the tile on the concrete mixture, the applied pressure may be less than 2 bar.

The pressure and vibration may be applied together or may be applied separately.

In another example, the method may optionally include, after removing the tile and concrete mixture assembly from the mold cavity, placing the tile and concrete mixture assembly curing the tile and concrete mixture assembly, for example in a chamber to form the tile product. Curing may include exposing the tile and concrete mixture assembly to an environment, such as in a chamber, with an increased moisture content and/or temperature over ambient air. For example, the increased moisture content may be in a range of about 10-100% more than ambient air. For example, the increase temperature may be in a range of about 1 degree F. to 200 degrees F. greater than ambient air.

In yet a further aspect, the method includes providing a mold cavity having a direction for removing the tile and concrete mixture assembly. The mold cavity includes a plurality of grooves extending in the direction for removing, wherein feeding the concrete mixture into the mold cavity includes filling the grooves with the concrete mixture to form one or more spacers for the tile product.

In another aspect, the method further includes vibrating the concrete mixture for a period of time. For example, the concrete mixture may be vibrated before positioning the tile on the concrete mixture for a period of time. In one aspect, the period of time may be at least 0.1 seconds. In other aspects, the period of time may be in a range of about 0.1 seconds to 120 seconds, optionally in a range of about 0.5 seconds to 30 seconds, and optionally in a range of about 0.5 seconds to 4 seconds.

In one example, the concrete mixture may be vibrated after positioning the tile on the concrete mixture for a second period of time. For example, the second period of time may be in a range of about 0.1 seconds to 120 seconds, optionally in a range of about 0.5 seconds to 30 seconds, and optionally in a range of about 0.5 seconds to 4 seconds.

In another example, the method may include vibrating and compressing the concrete mixture before and/or after placing the tile on the concrete mixture. Optionally, the method may include vibrating and compressing the tile and concrete mixture after positioning the tile on the concrete mixture to form the tile and concrete mixture assembly.

In addition, the settings for vibrating and compressing the concrete mixture before and after positioning the tile on the concrete mixture may be different. For example, the pressure applied to the tile and concrete mixture after the tile is positioned on the concrete mixture may be less than 2 bar. The pressure applied to the concrete mixture before the tile is positioned on the concrete mixture may be up to 100 bar.

The system includes a mold apparatus with an upper mold top and a lower mold base, which includes at least one mold cavity. The system further includes a concrete feedbox, which contains and is configured to dispense a concrete mixture into the mold cavity. The concrete feedbox is moved between the upper mold top and the lower mold base when the mold top and base are separated to dispense the concrete mixture. The system also includes an input conveyor that conveys tiles, which have had adhesive applied thereto, to a staging area where a robot with a robotic arm lifts at least one tile off the conveyor for placement in the mold cavity after the concrete feedbox has dispensed concrete into the mold cavity. The robotic arm is configured to place the tile with its adhesive side facing the concrete mixture in the mold cavity.

After being placed in the mold cavity, the tile and concrete mixture are joined in the mold cavity by the mold apparatus to form a tile and concrete mixture assembly. The tile and concrete mixture assembly is then removed from the lower mold base and then conveyed by a take-away conveyor. The take-away conveyor conveys the tile and concrete mixture assembly to a holding location, optionally an assisted curing location.

In one example, the upper mold top is configured to move toward the lower mold base to apply pressure and/or vibration to the concrete mixture in the mold cavity before the tile is placed on the concrete mixture, and optionally apply pressure and/or vibration after the tile is placed on the concrete mixture in the mold cavity.

In another example, the mold cavity in the lower mold base includes a removable plate that receives the concrete mixture and supports the concrete mixture in the mold cavity while the tile is placed on the concrete mixture. To remove the tile and concrete mixture assembly from the mold cavity, the lower mold base is raised relative to the removable plate to allow the removable plate to be used as a carrier while being conveyed to and supported while in the holding location.

In yet another example, the input conveyor includes a clamp assembly to invert the tile so that the adhesive side is facing down and the robotic arm may pick the tile from the clamp assembly after the tile is inverted and then place the tile in the mold cavity with its adhesive side facing the concrete mixture in the mold cavity.

The system further includes one or more controllers to control the various components, such as the conveyors, the mold apparatus, and the robot, which may have an onboard controller that receives instructions from a system controller to ensure proper timing of the tiles being delivered and the robot picking and placing the tile in the mold cavity.

Accordingly, the present disclosure describes a process for producing a tile product that reduces the stress on the tile while still forming a reinforced tile product suitable for use as a landscaping product.

### BRIEF DESCRIPTION OF THE DRAWINGS

FIG. 1 is a perspective view of a mold base of a molding apparatus for forming a landscaping tile product;

FIG. 2 is a flow chart of the process of forming a landscaping product;

FIG. 3A is a perspective view of a landscaping tile product formed by the mold base and the process of FIGS. 1 and 2;

FIG. 3B is a perspective view of an alternate landscaping tile product formed by the mold base and the process of FIGS. 1 and 2;

FIG. 4A is a side front elevation (insertion side) of the molding apparatus;

FIG. 4B a side elevation view of the mold base of the molding apparatus;

FIG. 4C is a plan view of a portion of the mold base of FIG. 4B;

FIG. 4D is an end elevation view of the mold base of FIG. 4B;

FIG. 4E is a perspective view of a mold top of the molding apparatus of FIG. 4A;

FIG. 4F is a front elevation view of the mold top of FIG. 4E;

FIG. 4G is a plan view of the mounting plate assembly of the mold top of FIG. 4E as viewed from the top of the mounting plate assembly that mounts the mold top to the molding apparatus;

FIG. 5 is a perspective view of another example of two side-by-side tile products made using the methods described herein;

FIG. 6 is a schematic drawing of a molding system for forming a landscaping tile product using the methods and components described herein;

FIG. 7 is a side elevation schematic of optional ramps that may be used in the molding apparatus to guide the feedbox across the mold cavity or mold cavities;

FIG. 8 is a front end elevation schematic of the feedbox and rails in the molding apparatus;

FIG. 9 is a schematic drawing of a concrete batch mixing system for use with a landscaping tile product molding system;

FIG. 10 is a schematic drawing of the concrete batch mixing system of FIG. 9 for delivering the concrete mixture to a molding system, such as the molding system of FIG. 6.;

FIG. 11A is a plan view of an embodiment of the tile product with grooves formed in opposed sides of the concrete base;

FIG. 11B is side view of the tile product of FIG. 11A;

FIG. 11C is an end view of the tile product of FIG. 11A;

FIG. 12A is a plan view of a modified mold base that is configured to form the grooves shown on FIGS. 11A-11C ;

FIG. 12B is an end view of the mold base of FIG. 12A;

FIG. 13A is a plan view of a reinforcement structure that may be used in the concrete base of any of the tile products described herein;

FIG. 13B is a plan view of modification to the reinforcement structure of FIG. 13A;

FIG. 13C is an end or side view of the reinforcement structure of FIG. 13B; and

FIG. 13D is a similar view to FIG. 13B illustrating the reinforcement structure of FIG. 13B encased in the concrete base of one of the tile products.

### DETAILED DESCRIPTION

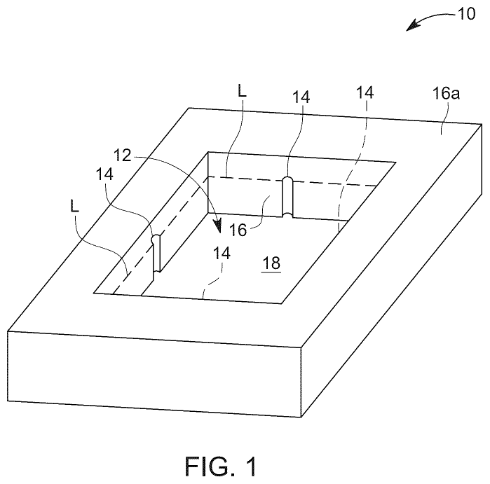

Referring to FIG. 1, the numeral 10 generally designates a mold base of a molding apparatus used to form a tile product from a tile, such as a ceramic or porcelain tile, and a concrete mixture that forms a concrete mixture base. A suitable molding apparatus includes a mold base (often referred to as a “mold frame”) with at least one mold cavity and a mold top (“tamper”) that optionally applies pressure to the concrete mixture and/or the tile in the mold cavity, as will be more fully described below.

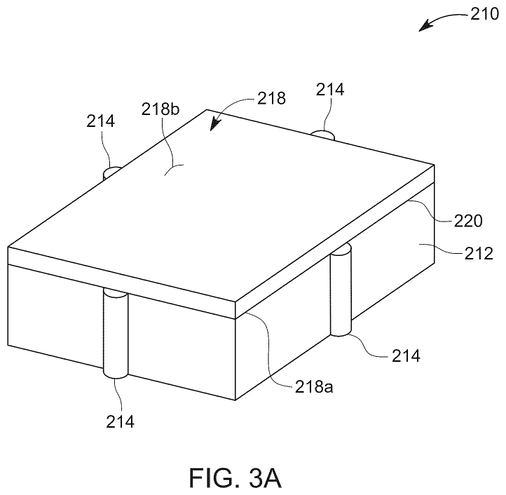

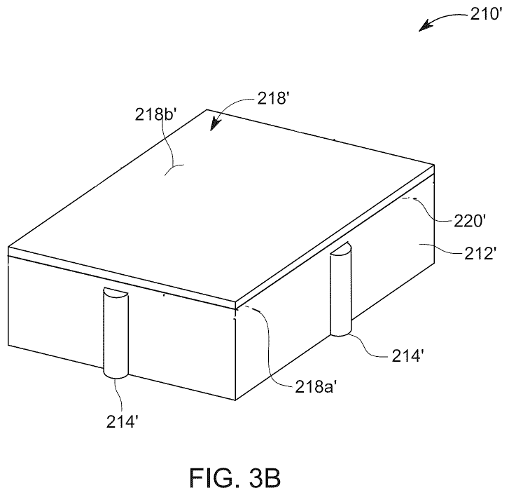

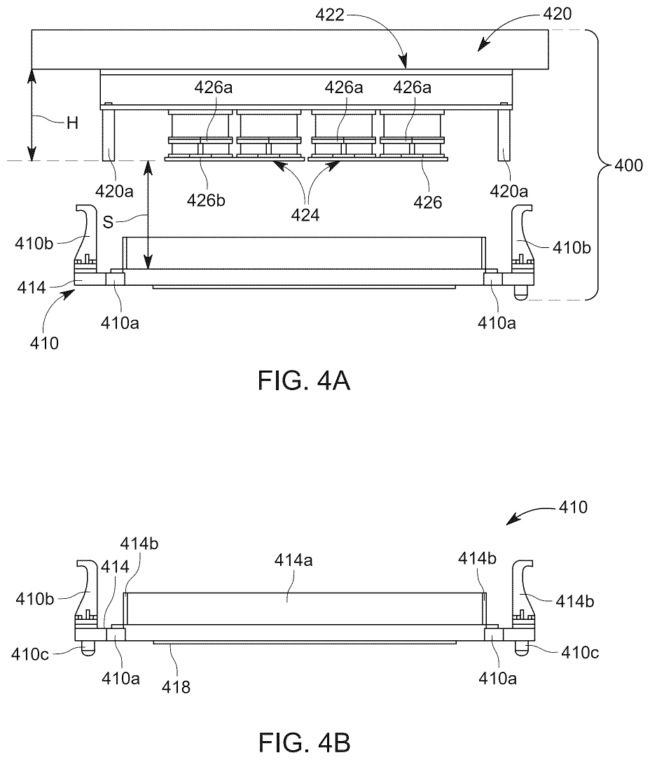

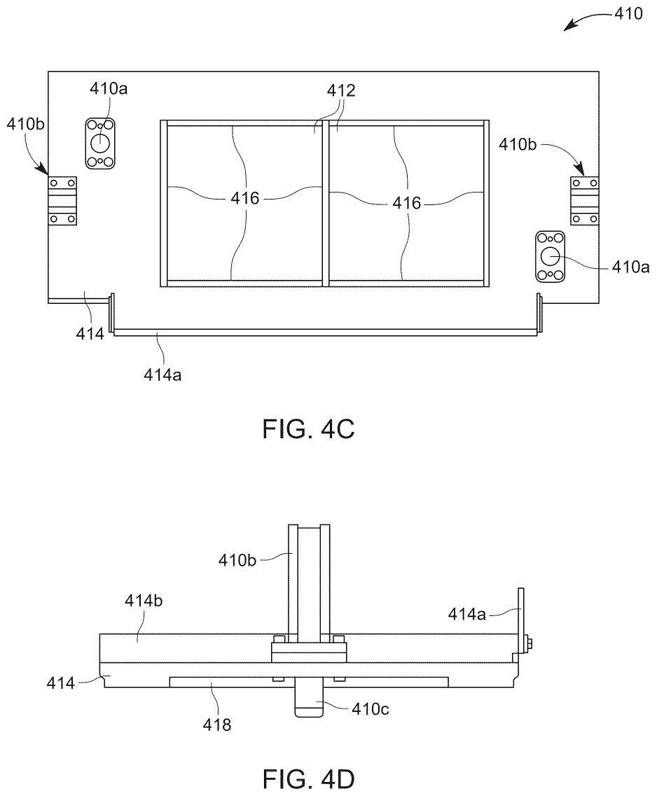

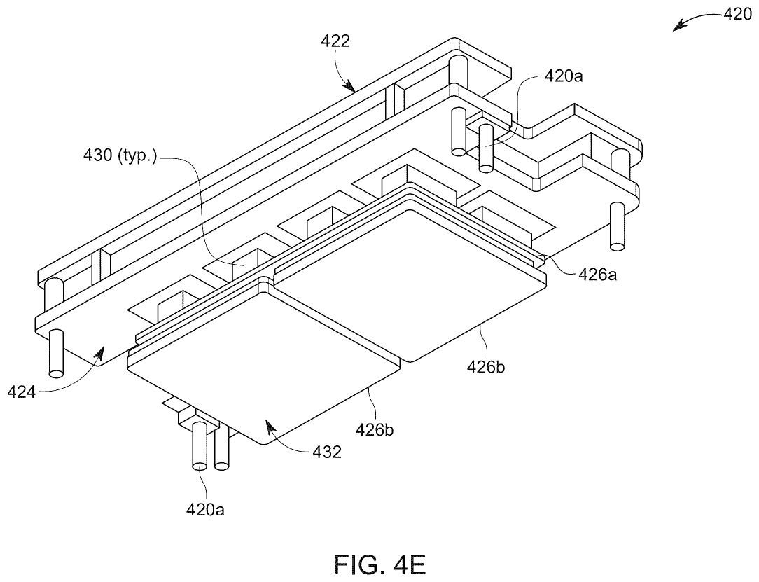

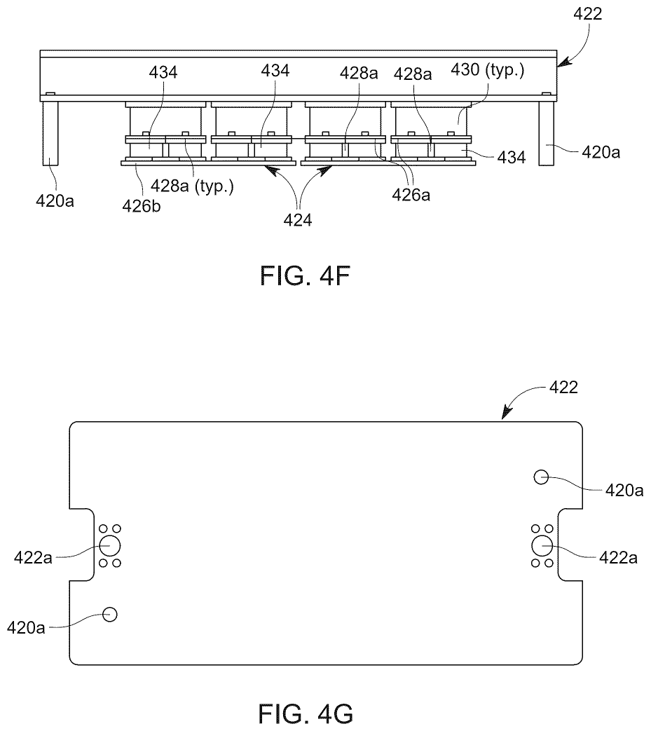

As best seen in FIG. 1, mold base 10 includes mold cavity 12 that is sized and shaped to correspond to the final tile product 210 (FIG. 3A) or 210′ (FIG. 3B). As noted above, the mold top is configured to tamp or compress the concrete material in the mold cavity 12 in the mold base 10, hence is often referred to as “tamper.” Further details of a suitable mold top will be described below to FIGS. 4A-4C.

The mold cavity 12 is defined by a liner that forms side walls 16. The mold cavity 12 may be sized so that the tile's outer perimeter closely fits inside the mold cavity's inside perimeter such that the tile is closely positioned to effectively seal the tile at the side walls 16 on all edges of the tile when the tile is placed on the concrete mixture in the mold cavity, described more fully below. This allows for precise alignment between the tile and the base formed by the concrete mixture. Further, as will be more fully described below, because the tile is placed or positioned on the concrete mixture after the concrete mixture is placed in the mold cavity, the travel of the tile in the mold apparatus can be minimized, which facilitates maintaining its planarity (lying in a horizontal plane) so that when the final products are placed next to each other in their final installed location the tiles will lie substantially in the same plane. Or stated another way, since the tile can have minimal travel distance into the mold cavity, an exact placement or location of the tile within the tile product can be achieved with uniform tolerance.

Referring again to FIG. 1, mold cavity 12 may include grooves 14 that are formed in the side walls 16 of mold cavity 12, which define the perimeter of the mold cavity 12. It should be understood that the grooves 14 may be omitted, and further as described above recessed below the tile. When provided, grooves 14 allow the concrete mixture that forms the concrete base (212, 212′) to form concrete projections, which act as spacers (often referred to as “spacer bars”). These concrete projections on the final tile product can ease placement of the tile product and, further, provide a space between adjacent tile products to receive joint filler, such as grout, sand, including polymeric sand or polymer modified sand, for example. Further, the concrete projections help resist rotation of the tile products and also may provide frictional interlocking of the tile products, to help stabilize the tile products during installation. In addition, the concrete projections may provide protection between the tile products during handling, such as during packaging and/or shipment.

Optionally, as shown, grooves 14 may extend from the mold cavity's base wall 18 to a level L (FIG. 1, L is not illustrated in proportion and instead exaggerated for ease of illustration) just below the tile (when the tile is placed onto the concrete mixture in the mold cavity) and, hence, just below the upper ends 16a of side walls 16 (see FIG. 3A). Alternately, the grooves 14 may terminate below level L and/or before the base wall 18 and, hence, the spacers (e.g., spacers 214′) will only extend over a portion of the height of concrete mixture base (FIG. 3B). As will be more fully described below in reference to FIGS. 4A-4D, the base wall 18 may be separable from the mold base to form a carrier (what is often referred to as a “production pallet”) to support the tile and concrete mixture assembly while being removed from the molding apparatus and transported for further handling and/or processing.

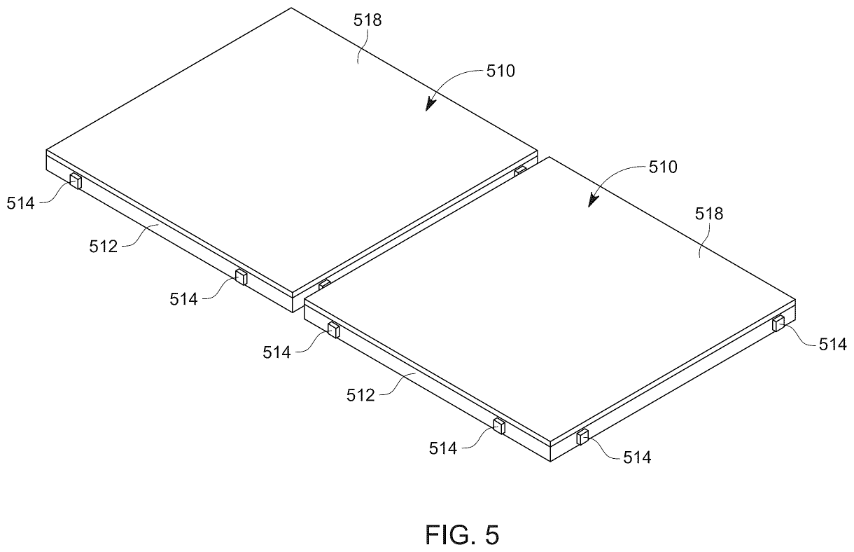

The number and shape of the grooves may vary. For example, as shown, one groove per side wall 16 may be provided (FIG. 1) or multiple grooves may be provided per side wall 16 to form multiple spacers on each side of the concrete base 512 (FIG. 5). Further, the grooves 14 may have a uniform cross-section, such as a rounded or arcuate cross-section, a multi-sided cross-section, including a triangular cross-section or a rectangular cross-section. Additionally, the grooves 14 may taper along their lengths. While illustrated as being orthogonal to the base wall 18 of mold cavity 12, the grooves 14 may be angled depending on the type of molding apparatus that is used.

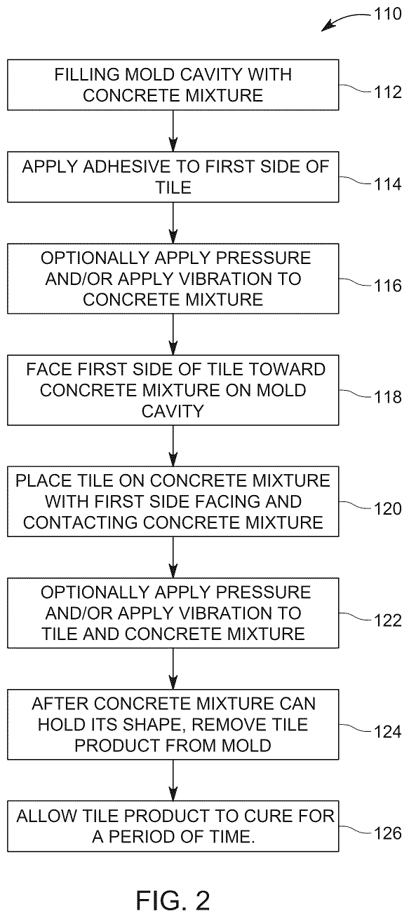

As best seen in FIG. 2, the process (110) to form the tile products 210, 210′ (FIGS. 3A, 3B) includes filling (112) the mold cavity 12 with a concrete mixture to form the concrete base 22, 212′. The concrete mixture is poured into the mold cavity 12 up to a level (L) (FIG. 1) that is just beneath the top of the mold cavity 12 (upper end of side walls 16) and which is beneath the upper ends 16a of side walls by at least the thickness of the tile. For example, the level L may be in a range of 2-4 mm or about 3 mm below the outwardly facing surface of the tile when the tile is placed on the concrete mixture (concrete base) in the mold cavity. In this manner, the space above the concrete mixture (after being poured into the mold cavity to form the concrete base) accommodates the tile 218 so that it is fully contained in the mold cavity 12.

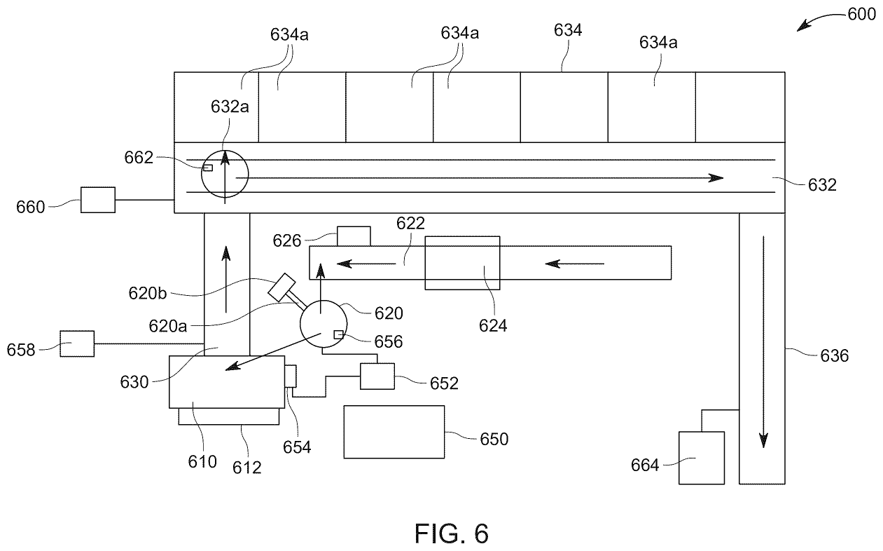

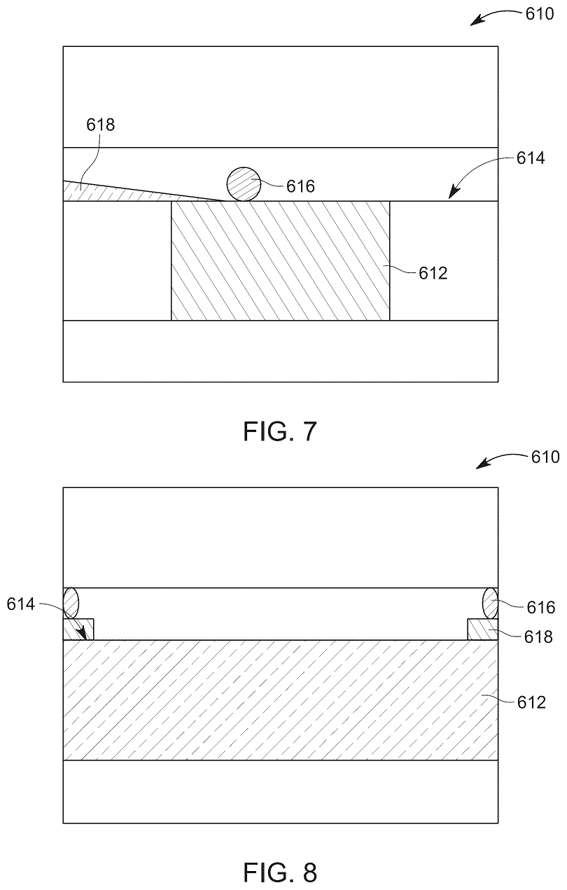

In one example, the concrete mixture is delivered to the mold cavity using a feedbox (see e.g., feedbox 612 in FIG. 6). The feedbox may be supported by rollers that move the feedbox into position between the mold top and the mold bottom (when the molding apparatus is opened). Further, as described in reference to FIGS. 7 and 8 below, ramps may be provided under the rollers that guide the feedbox over the mold to assist with better filling in hard-to-reach areas of the mold cavity. The ramps increase the amount of loose concrete mixture that is available, for example, for the front of the mold cavity. This can be challenging when a large volume of concrete is needed in a mold cavity, for example for larger tile products, such as 6″ by 6″ (150 mm by 150 mm) tile products or 2 ft by 2 ft (600 mm by 600 mm) tile products or 3.28 ft by 3.28 ft (1 m by 1 m) tile products. In this manner, the final tile product can be manufactured to a very tight height tolerance (for example, between 0.1 mm to 4 mm). For example, the ramps are configured to lift up the feedbox at pre-defined locations over the mold cavity (or cavities as described below) so that the loose concrete mixture does not fill too much at the back of the mold cavity, and instead allows more fill at the very front of the mold cavity, as noted above. In other words, the ramps provide a more even distribution of the concrete mixture in the mold cavity or cavities.

Prior to placing the tile on the concrete mixture, the concrete mixture may be densified. For example, pressure and/or vibration may be applied to the concrete mixture (116) to densify the concrete mixture for a period of time. In one aspect, the period of time may be in a range of 0.1 seconds to 120 seconds, or 0.5 seconds to 30 seconds, or 0.5 seconds to 4 seconds. In addition to densifying the concrete mixture, the vibration and/or pressure also further facilitates the concrete mixture flowing into all of the mold cavities, especially into the grooves to form spacers (e.g., 214, 214′) noted above. However, the step of densifying may be omitted.

The amount of pressure and/or vibration can vary depending on the flowability of the concrete mixture. Vibration can be achieved via a vibration motor that vibrates the molding apparatus, for example. The pressure, for example, can vary from less than 2 bar to about 8 bar, and optionally up to 100 bar.

In one embodiment, prior to placing the tile 218 in the mold 12, an adhesive is applied (114, FIG. 2) to a first side 218a, 218a′ (FIGS. 3A, 3B) of the tile 218, 218′ to form an adhesive layer. A suitable adhesive may be in liquid form or paste form and may include a polymer, such as a styrene butadiene or a polyurethane polymer. Optionally to maintain the flowability of the adhesive, the adhesive may be stored in a climate controlled environment, such as a climate controlled chamber, to keep the operating temperature of the adhesive above freezing but below 120 degrees F., or optionally in a range of about 38 degrees F. to 100 degrees F., or optionally in a range of about 70 degrees F. to 90 degrees F., and in some cases above freezing but less than about 80 degrees F.

Optionally, the adhesive layer 220 or 220′ may be allowed to partially set or partially cure to avoid migration of the adhesive after the tile is placed in the mold cavity on the concrete base 212, 212′. For example, the adhesive layer may be allowed to partially set or partially cure for one or more seconds. After the adhesive is applied (and optionally partially cured), the first side of the tile is faced toward the concrete mixture (118) and the tile 218, 218′ is then placed on the concrete mixture (120) (which forms the concrete base 212, 212′), with the first side 218a, 218a′ of the tile 218, 218′ and adhesive layer 220, 220′ contacting the concrete mixture (that forms the concrete base 212, 212′) and the decorative side 218b, 218b′ facing outwardly and upwardly from the mold base.

After the tile 218, 218′ is placed on the concrete mixture, pressure and/or vibration may be applied (122) to the tile to further densify the concrete mixture. For example, pressure and/or vibration may be applied to the tile and concrete mixture for a second period of time. In one aspect, the second period of time may be in a range of 0.1 seconds to 120 seconds, or 0.5 seconds to 30 seconds, or 0.5 seconds to 4 seconds. The pressure, for example, can vary from less than 2 bar to about 8 bar.

In addition, the settings for vibrating and/or compressing the concrete mixture before and after placing the tile on the concrete mixture may be different. For example, as noted, the pressure applied to the concrete mixture before the tile is placed on the concrete mixture may be up to 100 bar, while the pressure applied after the tile is placed may be less than 2 bar. Similarly, the first time period may be less than 4 seconds, and the second time period may be less than 1 second. Further, the vibration and pressure may be applied in separate steps or may be applied together. By bifurcating the bulk of pressure applied to the concrete mixture from the pressure applied to the tile, the method can reduce damage to the tile.

By placing the tile on the concrete mixture rather than placing the concrete on the tile, the concrete mixture will less likely cause residue on the decorative tile side of the tile. To further avoid concrete residue on the decorative tile side 218b, 218b′ (side opposite the first side 218a, 218a′) the method may include the step of removing any excess concrete mixture, such as by brushing and/or applying compressed air to the decorative tile side of the tile before the excess concrete mixture has dried. Therefore, if there is any excess concrete mixture on the decorative side of the tile, it will be immediately visible and can be immediately removed (and the tile decorative surface cleaned) even before the tile and concrete assembly is removed from the mold cavity.

Once the tile is placed on the concrete mixture in the mold cavity, and pressure and/or vibration is applied to the tile and concrete mixture, the tile and concrete mixture assembly that is now formed may be allowed to at least partially harden or cure (122) in the mold cavity to from the concrete base 212, 212′.

In one example, the concrete mixture is selected so that it is sufficiently stiff (e.g., low or zero slump concrete) and can hold its shape without needing any additional time to cure, especially after it has been compressed. Once the concrete mixture is sufficiently stiff (either through curing and/or compaction) so that it can hold its shape, the tile and concrete mixture assembly 210, 210′ is removed from the mold (124) and then allowed to harden further or at least partially cure (126). Curing can be achieved simply by the passage of time or by assisted curing, as described below, where the natural curing process is accelerated. It should be understood that the term “cure” is used broadly to mean harden to a desired level where it is sufficiently hard for handling and transport and not necessarily to achieve a full cure—which typically takes 28 days for most concrete mixtures.

The concrete mixture as noted may vary. For example, a suitable concrete mixture may comprise a conventional Portland cement, Type I with aggregate, or a fast-drying cement such as “High Early” or Type III cement. A suitable aggregate may include sand, sandstone, granite, granulate, cement and blast furnace slag, ranging from fine to course grade aggregate. Optionally, the concrete may include a combination of two or more aggregates. The size of the aggregate may vary and may include, for example, aggregate particle sizes in a range of about 2 to 8 mm. As will be more fully described below, a suitable concrete mixture may include a porous concrete mixture that is particularly suitable for use in an environment where freeze/thaw conditions are a consideration.

In one example, the concrete mixture includes sand in an amount of between 15 and 30%, optionally between 20 and 25%; granulate in an amount of between 55 and 75%, optionally between 62 and 69%; cement in an amount of between about 4 and 30%, optionally between about 12 and 25%, and optionally between about 12 and 18%, with the % calculated is based on % of weight.

Similarly, an aggregate may be added to the adhesive. For example, a suitable aggregate may include fine sandstone or quartz sand. The dimensions of aggregate added to the primer is preferably in the range of up to 1 mm.

Optionally, as understood with reference to the grooves described above, the concrete base formed by the concrete mixture may be dimensioned so that one or more portions of the base protrude at least partly beyond the perimeter of the tile. As described above, this allows for a space to be created between adjacent tiles when adjacent tile products are placed in an abutting relationship to allow grout or mortar or the like to be placed between adjacent tiles. As described above, in some examples, the concrete base is formed with projections that act as spacers, such as “spacer bars,” on one, two, three, or all four sides of the final tile product. Further, as described above, the projections may be recessed beneath the tile and may extend from just below flush with the decorative face of the tile for the full height of the concrete base or just a portion of the height of the concrete base. However, the projections alternately may be post applied using an adhesive.

In another example, after removing the tile and concrete mixture assembly from the mold cavity, the method may optionally include applying an assisted curing process. In one example, the assisted curing process includes placing the tile and concrete mixture assembly in a chamber with a controlled environment and curing the tile and concrete mixture assembly in the chamber. For example, the assisted curing may include exposing the tile and concrete mixture assembly to an environment in the chamber with an increased moisture content and/or temperature over ambient air. For example, the increased moisture content may be in a range of about 10-100% more than ambient air. For example, the increase in temperature may be in a range of about 1 degree F. to 200 degrees F. greater than ambient air.

According to another method, a tile is brought into contact with a concrete mixture in a mold with an adhesive applied to the side of the tile that faces the concrete mixture prior to contact with the concrete mixture. After the concrete mixture can hold its own shape, the tile and concrete mixture assembly is removed from the mold cavity and the placed in a chamber with an environment with increased humidity and/or temperature over ambient air to cure the tile product. Pressure and/or vibration may be applied to the concrete mixture before and/or after placing the tile in contact with the concrete mixture to densify the concrete mixture.

Referring to FIGS. 4A-4G, in another example, a molding apparatus 400 may include a mold base 410 with one or more mold cavities 412 for forming tile products 210, 210′ or 510 (FIGS. 3 and 5). For example, the molding apparatus 400 may comprise a heavy-duty molding apparatus commercially available from a large number of commercial manufacturers though with one or more modifications noted below.

Referring again to FIG. 4A, molding apparatus 400 includes a hardened steel mold top 420 (“tamper”) spaced from and movably supported relative to mold base 410 (often referred to as a “mold frame”) so that the two mold halves (top and base) can be opened or closed during the tile product forming process. The mold apparatus 400 is opened by moving the mold top 420 or mold base 410 away from the other, for example, on guides using one or more actuators, such as a motor or motors. In the illustrated example, the mold top 420 is supported above mold base 410 and is raised relative to the mold base 410 to open the mold apparatus, as will be more fully described below.

Referring to FIGS. 4E-G, in one example, mold top 420 includes a mounting plate assembly 422 that mounts the mold top 420 in the molding apparatus 400 via supports 422a, such as bolts or pins, and is raised or lower relative to mold base 410 by one or more actuators, which are under the control of a mold apparatus-based controller described below.

As best seen in FIGS. 4E and 4F, mounting plate assembly 422 supports a pair of movable steel plate assemblies 424 that correspond in number and size with mold cavities 412 and are used to apply pressure on the concrete mixture and/or tile (when positioned in the mold cavities 412 (FIG. 4F), as described above.

Movable steel plate assemblies 424 include upper and lower spaced apart steel plates 426a, 426b, which are secured together by bolts 428a. Lower plates 426b are often referred to as “shoes” and are moved to selectively contact and apply pressure on the concrete mixture and/or tiles (when positioned in the mold cavities 412 (FIG. 4F)). For example, plate assemblies 424 are supported on columns (often referred to as “plungers”) 430 that extend from mounting plate assembly 422 through sockets in the mounting plate assembly 422. Columns 430 are secured on their lower ends to upper plate 426a. As columns 430 are extended from or contracted into mounting plate assembly 422, columns 430 move the plate assemblies 424 toward or away from mold cavities 412 when aligned over the mold base 410, as controlled by the molding apparatus-based controller (described below).

Mold base 410 is movably mounted in the molding apparatus 400 by hooks 410b (FIGS. 4A and 4B) and further is supported on a bearing surface in the molding apparatus by supports 410c. In addition, the mold top 420 and mold base 410 each include respective guide pins 420a (FIG. 4E) and sockets 410a (FIGS. 4A and 4B) to form a tamper positioning system to guide and align mold top 420 onto the mold base 410 when the mold top is lowered by the molding apparatus. The guide pins 420a align with the sockets 410a during compression to ensure that the lower plates 426b (FIGS. 4E and 4F) (commonly referred to as “shoes”) are precisely aligned with the mold cavity 412 during each production cycle.

In the illustrated example, the mold top 420 has a lower height profile H (FIG. 4A) than a conventional molding apparatus (which is typically 850 to 900 mm in height) to allow greater access to mold base 410 for equipment, including robotic arms and the concrete feedbox described below, to form and process the tile product. For example, the overall height of the height profile of mold top 420 may be in a range of about 260 mm to 760 mm, optionally about 360 mm to 660 mm, and, optionally and, in one example, optionally about 430 mm. Or stated another way, the height profile of mold top 420 may be configured to provide a spacing S between the bottom of mold top 420 and the top of mold base 410 when opened in a range of about 300 mm to 800 mm, and optionally about 400 mm to 700 mm, and, in one example, optionally about 630 mm.

Optionally to reduce the risk of breakage, the mold top 420 may include molding surfaces (which contact the tile during the molding process) that are configured to reduce the stress on the tile. For example, plates 426b may have areas with or be fully laminated with a rubber coating 432 on at least their surfaces that come into contact with the tile during molding. For example, the rubber coating may be 2-8 mm thick or about 6 mm thick, and formed from highly durable rubber, such as polyurethane elastomer, that will cushion and protect the surface of the tile.

Additionally, as best seen in FIG. 4F, rubber inserts 434, such as rubber bumpers, may be located between the lower plates 426b and upper plates 426a that allows the lower plates to flex when applying pressure to the concrete mixture and/or tile, as described above. The rubber inserts 434 allow the lower plates 426b to articulate slightly relative to plates 426a and apply pressure where it is needed most to create a more even product.

Referring again FIGS. 4B and 4C, mold base 410 includes a base plate 414 to which hooks 410b are mounted and, further, which forms and supports the mold cavities 412. Additionally, base plate 414 may also support upwardly extending walls 414a and 414b to form a fence around the mold cavities. As noted above, one or more mold cavities may be provided. Similar to mold cavity 12, mold cavities 412 are defined by liners that form side walls 416 and, further, by a movable base wall 418 that defines the bottom wall of the mold cavities (commonly referred to as “a production pallet”). For example, base wall 418 may be formed by a base plate that is sized to hold one or more tile and concrete mixture assemblies in a planar side by side arrangement. Base wall 418 is supported on a conveyor section 411 located beneath mold base 410, which is straddled by the bearing surfaces noted above. In this manner, when the tile and concrete mixture assembly is formed in the mold cavity, the mold base 410 may be lifted leaving the base wall 418 still supported on the conveyor section 411 so that the conveyor section 411 can convey the tile and concrete mixture assembly away from the mold apparatus for further processing described below in reference to FIG. 6. Thus, the base wall 418 may support one or more tile and concrete mixture assemblies and, as such, act as a carrier or “production pallet” to support and transport the one or more tile and concrete mixture assemblies to the next step in the manufacturing process.

Referring to FIG. 5, in another example, a tile product 510, which is similar to product 210 and 210′, includes a tile 518 and concrete mixture base 512. In the illustrated example, tile product 510 includes multiple concrete projections or spacers 514 along each of its sides, which are similarly formed by grooves provided in mold cavities 412. Further, each spacer 514 is rectangular in shape forming a bar-shaped spacer. Again, spacers 514 may be recessed below the tile 518 (i.e., below the concrete facing surface, such as the downwardly facing surface, of the tile) so that they are not visible when the tile products are installed and the gaps between them filled with joint filler, as noted above.

In any of the above, the mold cavities may be configured to form channels in the concrete base or between the concrete base and the tile. These channels extend around the perimeter of the tile product and are parallel to the outwardly facing surface of the tile product. These channels can help with installation and allow the tile product to be used in a rail-type system, or the like, which engage the tile product via the channels and are, therefore, particularly suitable for decks, including roof decks, and/or installations that require fall through protection.

Referring now to FIG. 6, tile product manufacturing system 600 for forming a tile product, such as tile products 210, 210′, and 510, includes a mold apparatus 610. Similar to the above molding apparatuses, molding apparatus 610 includes a lower mold base, which includes at least one mold cavity, and an upper mold top, which may be configured to apply pressure and/or vibration to the concrete mixture and tile once deposited in the mold cavities. For further details of the molding apparatus 610 reference is made to molding apparatus 10 or 400 described above.

The tile product manufacturing system 600 further includes a concrete feedbox 612, which is supported on rails by bearings, such as rollers, so that the feedbox can be moved along the rails from a non-dispensing position to dispensing positions between the mold top and the mold base (when opened) to deposit a concrete mixture into the cavity or cavities in the mold base (e.g., see FIGS. 7 and 8). For example, the concrete feedbox 612 may be located inside the molding apparatus 610 but outside the footprint of the mold top and the mold base or outside the molding apparatus 610. For further details of the concrete mixture, reference is made to the molding process described above.

In one example, as best seen in FIGS. 7 and 8, the concrete feedbox 612 may be suspended by a pair of rails 614 by bearings 616, such as rollers, with the rails 614 extending into the molding apparatus but outside the footprint of the upper mold top. Rails 614 may include ramps 618, as noted above, or be configured as ramps to raise the feedbox at pre-defined locations over the mold cavity (or cavities as described above) so that the loose concrete mixture does not fill improperly, such as fill too much at the back of the mold cavity, and instead allows more fill at the very front of the mold cavity, as noted above. In other words, the ramps provide a more even distribution of the concrete mixture in the mold cavity.

The tile product manufacturing system 600 also includes a robot 620 with a robotic arm 620a fitted with an end of arm tooling 620b that is configured to clamp onto one or more tiles that are or are conveyed to the staging area from the input conveyor 622. Optionally, the end of arm tooling 620b may be configured to clamp onto two or more side by side tiles when the molding apparatus has two or more mold cavities so that the multiple tiles are picked and placed at the same time into the mold cavities. It should be understood that the tiles may be individually picked and placed in a mold cavity of a multi-mold cavity molding apparatus, but as would be understood this could slow down the manufacturing process.

In addition, tile product manufacturing system 600 includes an adhesive dispensing and applicator system 624, which straddles input conveyor 622. For example, adhesive dispensing and applicator system 624 may include a dispensing apparatus, such as an array of adhesive spray nozzles, and rollers to spread the adhesive and apply the adhesive across the upwardly facing side of each tile while supported on the input conveyor 622.

To invert the orientation of the tile (or tiles) before being picked up by the robot 620 off input conveyor 622, tile product manufacturing system 600 may also include a clamp assembly 626. Clamp assembly 626 is located adjacent input conveyor 622 at the staging area and is configured to clamp onto the edges of one or more tiles so that the tile (tiles) can be inverted so that the adhesive side (sides) is (are) facing down after they are inverted. In this manner, the robotic arm 620 may pick the tile (or tiles) from the clamp assembly 626 after the tile is inverted and then place the inverted tile (or tiles) in the mold cavity with its adhesive side facing the concrete mixture in the mold cavity.

After robot 620 has picked and placed the tile (or tiles) in the mold cavity (or cavities), and the robotic arm 620a is removed from between the upper and lower mold halves (mold top and mold base), the robotic arm 620a is returned to a home position, while the next tile or tiles is delivered by the input conveyor 622 to the staging area. After clamp assembly 626 has inverted the next tile or tiles, the robot 620 moves its robotic arm 620a to its picking position over the clamping assembly 626 to clamp onto and pick up the next tile (or next set of tiles) from clamp assembly 626 for placement in the mold cavities of the molding apparatus 610.

As described above, molding apparatus 610 may include a base wall, commonly referred to as “production pallet,” which is supported on a conveyor section (similar to conveyor section 411) that extends beneath the lower mold base. After the tile and concrete mixture have been formed and then processed in the mold cavity (e.g., pressure and/or vibration applied) to form the tile and concrete mixture assembly (or assemblies), the lower mold base is raised leaving the base wall and the tile and concrete mixture assembly (or assemblies), which are supported on the conveyor section, which conveys tile and concrete mixture assembly (or assemblies) to takeaway conveyor 630. For further details of the tile and concrete mixture assembly molding process, reference is made to the molding process described above

The takeaway conveyor 630 then conveys the tile and concrete mixture assembly (or assemblies) from the molding apparatus 610 to a second conveyor 632. The second conveyor 632 supports and transfers the tile and concrete mixture assembly (or assemblies) to a holding location 634 where the tile and concrete mixture assembly (or assemblies) can harden. Optionally, the tile and concrete mixture assembly may be held in a holding location 634 where the concrete base hardens under ambient conditions. Alternatively, holding location 634 may include one or more curing chambers 634a with a controlled environment, as described above.

For example, holding location 634 may extend adjacent second conveyor 632 and include a plurality of racks each with a plurality of vertically spaced shelves for supporting a plurality of tile and concrete mixture assemblies. In one example, the second conveyor 632 includes a transfer car 632a that is operable to place and retrieve one or more tile and concrete mixture assemblies on and from the shelves of each rack where the tile and concrete mixture assemblies can sit while the concrete mixture hardens or is “assist cured” as noted above. For further details of the optional assisted curing steps, reference is made to the assisted curing process described above.

To place and retrieve the tile and concrete mixture assemblies, the transfer car 632a may include a pair of arms that are configured to place or retrieve the one or more tile and concrete mixture assemblies on or from the shelves of a rack. Further, the transfer car 632a may include a plurality of vertically arranged arms that are configured to move vertically and place or retrieve a stack of the tile and concrete mixture assemblies on or from the vertically arranged shelves at the same time.

Additionally, the transfer car 632a may be supported on a turntable on the second conveyor 632 so it can rotate between a first orientation with its arms facing the first take away conveyor 630 to receive incoming tile and concrete mixture assemblies and a second orientation with its arms adjacent and facing one of the racks in the holding location 634 to place or retrieve the tile and concrete mixture assemblies. The transfer car 632a is further configured to move along the second conveyor 632 to align with a respective rack in the holding location 634 so that stacks of tile and concrete mixture assemblies can be placed and then retrieved after the respective tile and concrete mixture assemblies have sufficiently hardened or cured for further handling as described below.

After the tile and concrete mixture assemblies have sufficiently hardened to form the tile products and have been retrieved by the transfer car 632a, the transfer car 632a is then conveyed by the second conveyor 632 to a third conveyor 636. which forms a packaging line and receives the stack from the transfer car 632a after the transfer car 632a has been reoriented to its first orientation so that the third conveyor 636 may convey the stack of tile products while packaging the stack of tile products.

Once the tile and concrete mixture assembly or assemblies are removed from the mold cavity (or cavities), and prior to placing the next tile (or tiles), a new base wall is moved under the mold base and the feedbox is moved across the mold cavity or cavities to dispense a preselected amount of concrete mixture into the mold cavity or cavities and onto the new base wall. As noted above, optionally the concrete mixture may be vibrated and/or compressed by the mold apparatus to prepare the concrete base for the tile or tiles. Once vibrated and/or compressed, the mold top is raised and the robotic arm 620a moves from its picking position to its placing position in between the two mold halves to deposit the next tile or next set of tiles on the concrete mixture in the mold cavity or cavities.

In order to control the molding system components, the molding system may include one or more controllers. The controllers may comprise one or more microcontrollers, field programmable gate arrays, systems on a chip, discrete circuitry, memory, and/or other suitable hardware, software, or firmware that is capable of carrying out the functions described. One or more of the controllers may be configured as a programmable logic controller (PLC) of the system.

In one example, the controllers include a system or master controller 650 that controls the operation of the conveyors, the robot, and the mold apparatus either directly or through sub-controllers and/or local controllers. System controller 650 may also control components associated with the conveyors, such as the clamping assembly 626, the adhesive dispensing and applicator system 624, and the packaging system as well as the operation of the optional curing chambers 634a, again either directly or through sub-controllers or local controllers.

For example, system 600 may have a sub-controller 652 that controls the molding apparatus 610 (e.g., to control the movement of upper and lower mold halves (mold top and mold base)) via a local mold-based controller 654, controls robot 620 (to control movement the robot itself and of its robotic arm 620a, as well as the end of arm tool 620b) via a local robot-based controller 656. Sub-controller 652 may also control input conveyor 622, adhesive dispensing and applicator system 624, and clamping assembly 626 based on input from system controller 650.

In addition to controlling movement of the upper and lower mold halves, local mold-based controller 654 may control the conveyor beneath the mold base and the movement and dispensing of the concrete mixture from the feedbox, based on input from system controller 650.

Sub-controller 652 may be configured to sequence the robot and its robotic arm movement with the clamping assembly as well as the molding apparatus to avoid collisions between any of the respective components.

Further, take away conveyor 630 may include a local conveyor controller 658, which is in communication with and controlled by system controller 650. Similarly, second conveyor 632 and transfer car 632a may each have a respective local controller 660 and 662, which are in communication with and controlled by system controller 650 to achieve the functionality and sequencing described herein. In addition, conveyor 636 may have a local controller 664, which is also in communication with system controller 650 and which controls the flow of tile products along conveyor 636.

System controller 650 and/or sub-controller 652 may be configured to coordinate and sequence the movement of the conveyors 622 and 630, clamping assembly 626, and robot 620 to ensure the tile or tiles are conveyed to the staging area at the appropriate times for being inverted by the clamp assembly. The sequencing may include conveying the tile or tiles with a first speed and then halting the input conveyor when the tile or tiles are at the staging area until the tile or tiles are inverted by the clamping assembly. Once the first tile or first set of tiles are lifted off the input conveyor the input conveyor 622 may then again be operated to convey the next tile or set of tiles to the staging area. This pause is sufficient to allow the clamping assembly to clamp onto and then invert the tile or tiles ready for pick up by the robot 620.

In one example, input conveyor 622 includes two or more conveyor sections, with each conveyor section controlled by system controller 650 (either directly or via sub-controller 652) so that each tile may be conveyed to the staging area independently.

The conveyors described herein may comprise conventional motorized conveyors, including conventional belt conveyors with two or more discrete spaced belts for supporting the tile without damaging the tile or conventional motorized chain conveyors with two or more spaced chains suitable when supporting the base walls and which do not directly make contact with the tiles.

As noted above, the concrete base of any of the above tile products, may be formed with a porous concrete mixture to produce a porous or pervious concrete base. For example, referring FIG, 9, a concrete batch mixing system 760 may be provided that produces a concrete mixture that is porous so that the tile product is more suitable for environments where there is a freeze/thaw concern. For example, the concrete base may be semi-permeable with a permeability in a range of about 15 to 25, or about 15 to 200 or in some cases greater. In this manner, concrete batch mixing system 760 together with the molding system, such as any of the molding systems described herein, can produce a tile product with a frost-resistant permeable concrete base. This can eliminate movement of the tile product after installation, reduce the weight of the tile product compared to a product with a conventional concrete base (or allow the product to be increased in size without the attendant increase in weight), and also produce a less embodied carbon than conventional concrete.

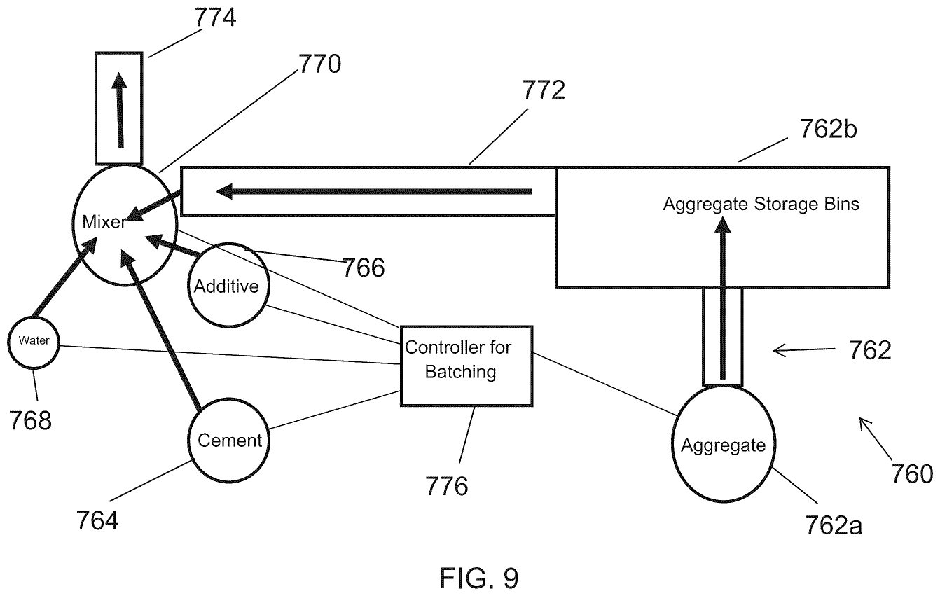

Referring again to FIG. 9, concrete batch mixing system 760 includes a supply of aggregate 762, a supply of cement 764, a supply of additive 766, and a supply of water 768, which are delivered to a mixer 770 in preselected amounts to produce a concrete mixture that is porous when cured. Further, similar to the first embodiment, when mixed and placed in or feed to the mold cavity, the concrete mixture may be a zero or low slump concrete mixture (before it is cured).

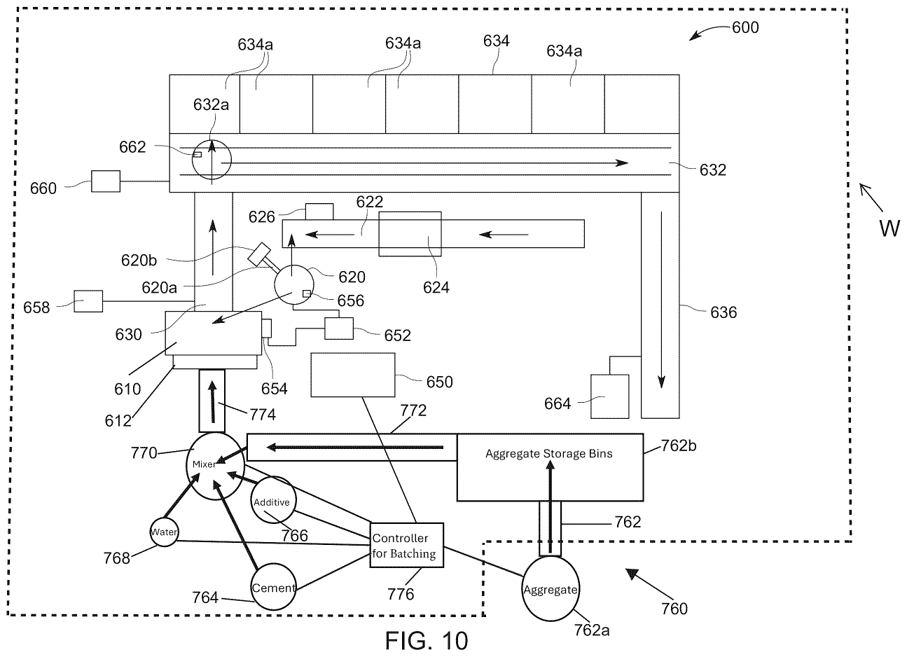

For example, the supply of aggregate 762 may include an external supply of aggregate 762a. For example, a supply of aggregate that is external to the enclosed facility W, such as a warehouse (see FIG. 10) that produces the tile products. The supply of aggregate may be fed, for example, via a chute or conveyor, to an internal storage bin 762b, which is internal to the enclosed facility W. The aggregate is conveyed from the supply of aggregate 762, for example, from the storage bin 762b, to mixer 770 via a conveyor 772 where it is mixed, as noted, with the cement, water, and the additive to form a zero or low slump concrete mixture.

A suitable aggregate may include sandstone, granite, granulate, cement and blast furnace slag, ranging from course to very course grade aggregate. Optionally, the concrete may include a combination of two or more aggregates. The size of the aggregate may vary and may include, for example, aggregate particle sizes in a range of about 2 to 20 mm, about 3 to 15 mm, or from about 5 to 10 mm. Although sand maybe be included in the aggregate (which can have a size in a range of 0.075 mm to 2 mm), the porous concrete mixture typically has little, for example less than about 2-10%, or about 4-8% or about 5% by weight sand, to no sand (devoid of sand) to create a substantial void content. For example, the void content of the final cured concrete base may vary from 10% to 35% or from 15% to 25%.

A suitable cement may comprise a conventional Portland cement, Type I with aggregate, or a fast-drying cement such as “High Early” or Type III cement. For example, a suitable water-to-cement ratio may include 0.28 to 0.4 to produce a void of about 15 to 25%.

A suitable additive includes a polymer, such as pure acrylic or EVA (ethylene-vinyl acetate) or VAE (vinyl-acetate ethylene) and may be in the form of a single component liquid, but also could be in the form of a combination of liquids, a powder, a combination of powders, or a combination of liquid(s) and powder(s), which prevent freeze thaw degradation. Some polymers increase the concrete's workability and flowability. In other words, the addition of some polymers can reduce friction between the cement particles and aggregates, thus improving the ease with which the concrete flows and consolidates in the mold. This allows for easier filling of intricate molds and reduces the amount of vibration needed to distribute the concrete mixture within the mold.

Some polymers, such as a polymer resin VINSOL can act as air-entraining agents, creating tiny, dispersed air bubbles within the concrete. This can improve the concrete mixture's workability and reduce the potential for unintentional voids in the finished product.

The amount of aggregate, cement, water, and additive delivered to the mixer is controlled by a controller 776, which may also control the speed of conveyor 772. In addition, controller 776 may also control the flow of the concrete mixture to the molding system via a conveyor, described below. Further, controller 776 may be in communication with a system controller of the molding system, such as controller 650 of molding system 600, which controls the operation of the conveyors, the robot, and the mold apparatus 610 of molding system 600, as described above and illustrated in FIGS. 6 and 10.

Referring to FIG. 10, the concrete mixture produced by concrete batch mixing system 760 may be directed to the feed box 612 of molding system 600 via a chute or a conveyor 774. Similar to the previous embodiment, hopper 612 feeds the concrete mixture from concrete batch mixing system 760, which is a porous, low or zero slump concrete mixture, into the mold cavity of molding apparatus 610. For further details of a suitable molding process reference is made to the above description.

In one embodiment, the concrete mixture may be vibrated in the hopper before or while being fed into the mold cavity. For example, the concrete mixture may be vibrated for a period of time ranging from 0.25 seconds to 10 seconds or more. In this manner, after the concrete mixture is fed to the mold cavity, the molding apparatus may simply tamp the concrete mixture prior to placing the tile. Once the tile is positioned on the concrete mixture in the mold cavity, pressure (low) may be applied to the tile and optionally the molding apparatus may be simultaneously vibrated.

Thus, instead of having a solid, essentially impermeable concrete base for the tile products 210, 210′, and 510, the tile products formed with systems 600 and 760 may have a concrete base with a low or zero slump characteristic and, further, a concrete base that is sufficiently porous to allow liquid, such as water, to flow through the base either vertically where the base is exposed and/or laterally. In addition, as noted, with the increased porosity of the concrete mixture, the density of the concrete base can be reduced, for example, to a density of 80-130 lbs. per cubic foot, or in some embodiments 128-130 lbs. per cubic foot, and hence produce a lighter tile product for a given size.

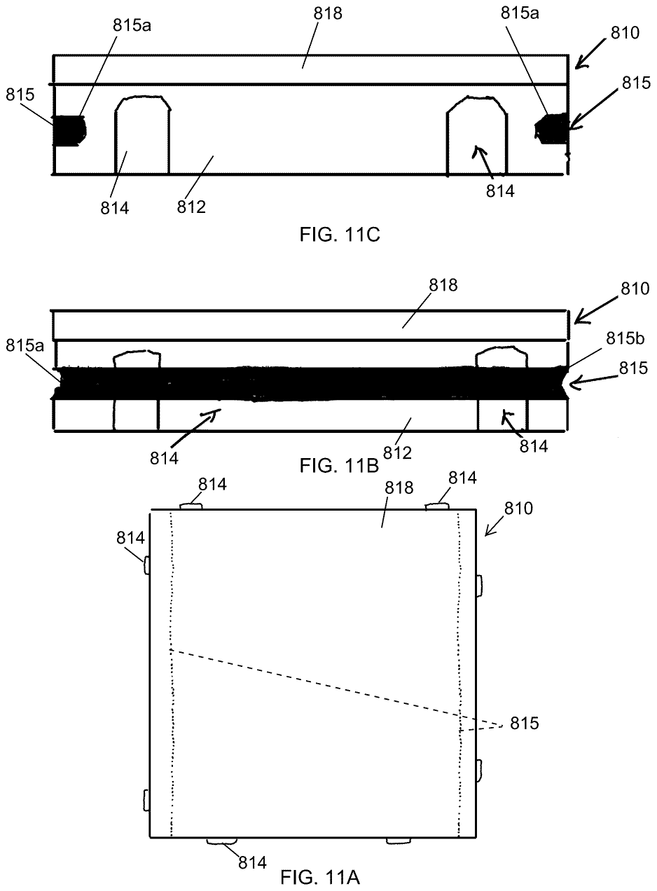

In other embodiments, similar to the previous embodiment, after the porous, zero or low slump concrete is fed in the mold cavity, the mold apparatus is optionally vibrated and/or tamped. Once the mold cavity is filled to the desired level, and optionally vibrated and/or tamped, the tile is placed on the concrete mixture. After the tile is placed on the concrete mixture, vibration and/or pressure (typically lower pressure) may then be applied to the tile. For details of the adhesive that may be applied to the tile prior to being placed in the mold cavity reference is made to the above description. Depending on the final product's application, it may be desirable to form one or more grooves, such as channels, in the concrete base (FIGS. 11A-11C) to provide engagement surfaces for mechanically attaching the tile product in its mounting location, for example, via brackets. The number and size of the grooves may vary. For example, the grooves may be provided on one side in certain applications, on two sides or on all four sides in other applications. Further, the grooves may run the full width of the tile product or may be provided in discrete locations along opposed sides of the concrete base, spaced below the tile but above the lower side of the concrete base. The grooves can be configured with a variety of cross-sectional different shapes (square, round, D-shaped, channel shaped, or the like) and dimensions (depth or thickness) to allow engagement by a rail system or to form notches for an elevated decking application or rooftop setting. In this manner, the tile products may be more stable in wind uplift situations. Further, the grooves may make installation easier for elevated decks.

Referring to FIG. 11A, any of the above tile products (e.g., 210, 210′, or 510) may be formed in a similar manner to tile product 810. As best seen in FIG. 11A, tile product 810 includes a concrete base 812 and a tile 818, which is joined with concrete base 812 in the same or similar manner to any of the methods described above. Further, concrete base 812 may or may not include spacers 814. For further details of optional spacers 814 reference is made to the above description.

As noted, tile product 810 may include one or more grooves 815. In the illustrated embodiment, grooves 815 extend the full length of the opposed sides of the concreate base 812 so that they form openings 815a at one end of concrete base 812 and openings 815b at the other end of concrete base 812 (FIG. 11B).

To form the grooves (e.g., when the grooves run the full width of the tile product), the mold apparatus may include deployable elements, such as fingers, rods or cables, which extend into the mold cavity to form the grooves. For example, the fingers, rods or cables may be actuated (e.g., hydraulically, pneumatically, or electrically) to move from a stowed position outside the mold cavity to their deployed positions inside the mold cavity and then returned to their stowed position after the concrete mixture has filled the mold cavity and set sufficiently to hold its shape. When grooves are desired on all four sides of the concrete base, bi-directional “core pullers” may be used, for example.

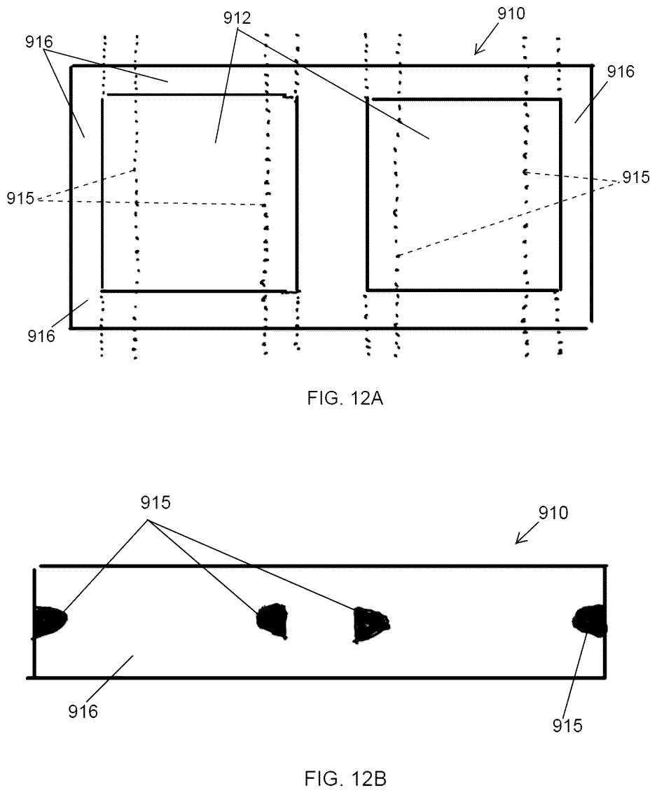

Referring to FIGS. 12A and 12B, any of the above tile product manufacturing systems may include a molding apparatus with a lower mold base, which includes at least one mold cavity, and which is configured to form the grooves in the concrete base. An upper mold top (not shown in these figures) may be provided that is configured to apply pressure and/or vibration to the concrete mixture and tile once deposited in the mold cavity or cavities, such as described above.

As best seen in FIG. 12A, mold base 910 includes a pair of mold cavities 912, with each mold cavity defined by side walls 916. The molding apparatus further includes rods or cables 915 that extend through the side walls 916 and into and through the mold cavities 912 to create the grooves 815 in the concrete bases formed in cavities 912. The rods or cables are deployed into the mold cavities 912 before the concrete mixture is fed into the mold cavities, but then retracted from the mold cavities after the concrete mixture forming the concrete bases has set sufficiently so that they can hold their shape, for example, just before the tile and product assemblies are removed from the molding apparatus. In another embodiment, any of the molding systems described above may include a post curing process where a layer of the concrete base of the tile product is removed, such as by grinding or honing, so that the finished tile product has a height that meets a desired height within tight tolerances so that the height across its entire width and length is exact and precise, which may be desired and/or required in some applications.

In yet another embodiment, the concrete base may be reinforced. For example, a reinforcement structure or structures may be placed in the mold cavity or cavities before the concrete mixture is fed into the mold cavity or cavities.

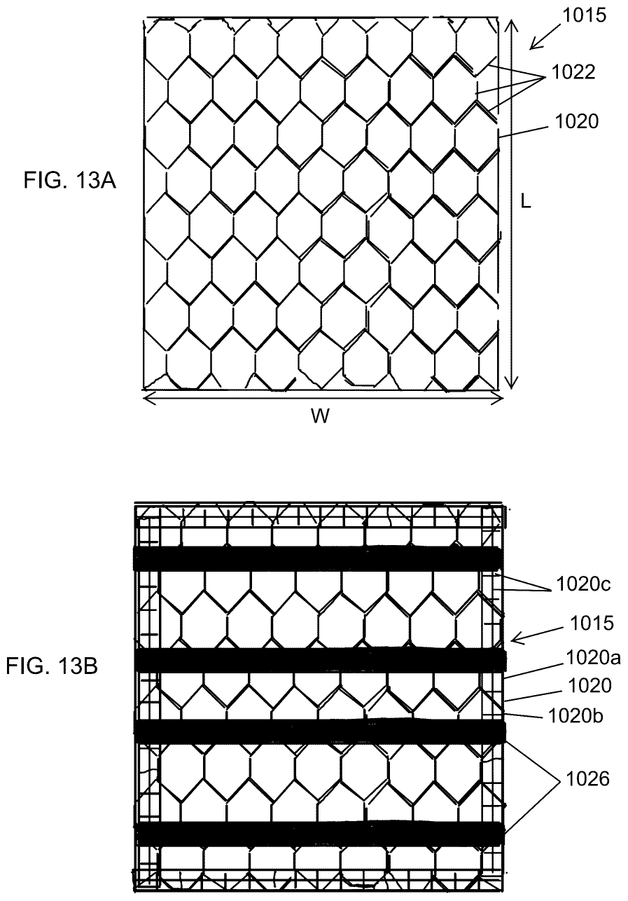

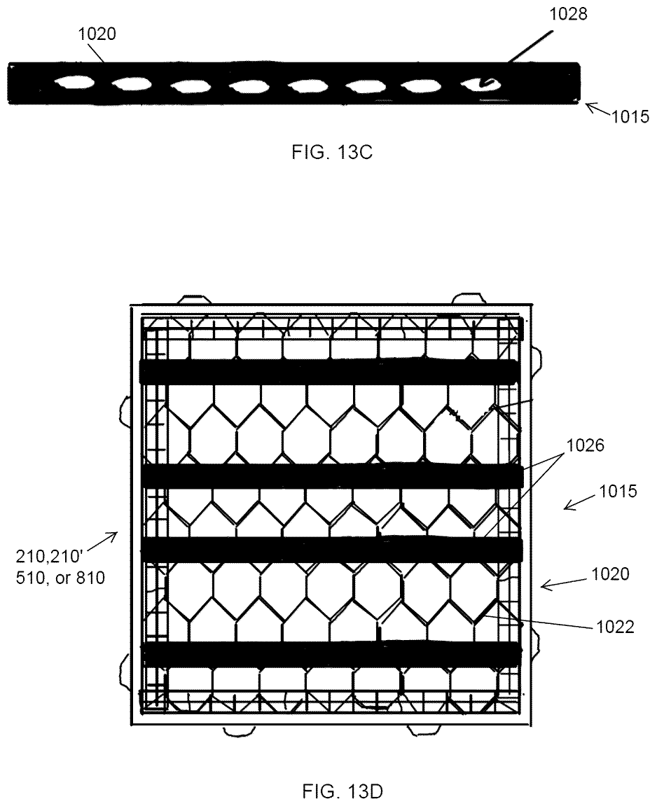

For example, as best seen in FIG. 13A, in one embodiment, a reinforcement structure 1015 may have a grid or honeycomb configuration, which may be placed in the mold cavity, for example, via a robotic arm prior to filling the mold cavity with the concrete mixture. The reinforcement structure 1015 integrates into the concrete mixture substrate to increase the bearing capacity and improves the resistance to breakage by reinforcing the concrete base through the perforated or cross channel structure. The reinforcement structure 1015 is sized so that it extends across the length and width of the concrete base but may be sized so that it is fully encased or encapsulated by the concrete mixture, and hence not visible from any side of the concrete base once the concrete base is formed. In this manner, the width (W) and the length (L) of reinforcement structure 1015 is selected to be less than the corresponding width and length of the concrete base.

The height of the reinforcement structure 1015 is also selected so that it is not visible from the top or underside of the concrete base. Optionally, the height of the reinforcement structure 1015 is selected so that it is mostly confined to where it is needed, i.e., the section of the concrete base that undergoes bending. Therefore, when placed in a respective mold cavity, the reinforcement structure 1015 may be supported (e.g., by offsets) above the bottom of the mold cavity so that it is not visible from the underside of the concrete base. It should be understood though that the reinforcement structure 1015 may instead be directly supported and make contact with the bottom of the respective mold cavity so that it is visible from the underside of the concrete base. Referring again to FIG. 13A, and as noted above, reinforcement structure 1015 may have a honeycomb configuration with an outer perimeter wall 1020, which forms the sides of the reinforcement structure and which are interconnected by internal walls 1022 arranged in a honeycomb pattern, for example, in a planar array. The perimeter wall 1020 and internal walls 1022 are oriented so that they are generally orthogonal to the concrete facing side of respective tile and their heights are arranged along the axis of the mold draw (e.g., vertically) so that when the concrete mixture is fed into the mold cavity the concrete mixture will pass between the perimeter wall and internal walls of the reinforcement structure 1015, and between the perimeter wall 1020 and the mold cavity side walls.

Reinforcement structure 1015 may be formed as a monolithic structure or may be assembled from two or more subassemblies. Further, referring to FIGS. 13B and 13D, reinforcement structure 1015 may incorporate additional reinforcement. For example, perimeter wall 1020 may be formed from inner and outer perimeter walls 1020a, 1020b, which are interconnected by internal walls 1020c (FIG. 13B).

Further reinforcement may be provided in the form of transverse members 1026 (FIGS. 13B and 13D), which extend across the reinforcement structure 1015 and which may be used to form mounting surfaces for mounting the finished tile product via mechanical fasteners, such as threaded fasteners. Transverse members 1026 may have the same height as the internal walls 1022 or may have a greater or lesser height than the internal walls 1022. Transverse members 1026 may be rectangular and have solid cross-sections or hollow cross-sections, such as formed by webbed cross-sections. Further, transverse members 1026 may include predrilled mounting openings formed therein, which may be more suitable when the reinforcement structure is visible from the underside of the concrete base.

As best seen in FIG. 13C, to facilitate the flow of concrete through the reinforcement structure 1015, the sides of perimeter wall 1020 may include transverse openings 1028 to allow the concrete mixture to flow sideways through the reinforcement structure 1015 to better pass through and also to conform to the reinforcement structure.

As best seen in FIG. 13D, and as described above, when the reinforcement structure 1015 is placed in the respective mold cavity and the concrete mixture is fed into the mold cavity, the concrete mixture will surround and encapsulate the reinforcement structure 1015, passing between the outer perimeter wall 1020 and the mold cavity side walls to form the outer perimeter of the concrete base and also the optional spacers. The perimeter wall and internal walls of the reinforcement structure 1015 are oriented so that they are generally orthogonal to the respective tile and also generally parallel to the spacers.

Accordingly, the method and system described herein of forming a monolithic tile product from a tile and concrete mixture includes filling a mold cavity with a concrete mixture and placing a tile on the concrete mixture, which tile has an adhesive applied to its side that faces the concrete mixture. Pressure and/or vibration may be applied to the concrete mixture before and/or after placing the tile on the concrete to densify the concrete mixture. Because the concrete can be at least partially densified before the tile is applied to the concrete mixture, the method reduces the risk of cracking the tile. Further, because the tile is placed into the mold cavity at the top of the mold cavity, the tile has very little distance to travel within the mold—for example, the tile's travel distance is about the thickness of the tile. This too helps reduce the risk of cracking the tile.

As would be understood from the description of the above process, the present method of forming the tile product allows for tile inspection immediately after production (even before it is removed from the mold cavity) to allow for quality control rejections, if necessary. Further, as noted, in one example, due to the concrete mixture being placed in the mold first, at least some of the densifying (or compaction) can be achieved before placing the tile on the concrete mixture. Hence the amount of pressure on the tile may be reduced, which can greatly reduce the risk of cracking the tile. The risk of cracking the tile may further be reduced using the rubber coated “shoes.” Further, because the mold base is raised, with the tile product (e.g., tile products 210, 210′, or 510) supported on the base wall (or the base wall is lowered), the “direction of draw of the mold” avoids interference between side walls (e.g., side walls 16, 416, 616) and the spacers (e.g., 214, 214′ or 514) even with the spacers terminating below the tile (i.e., below the bottom facing surface of the tile). This allows the spacers to be recessed below the tile so that when the tile products are positioned on the underlying support surface, the spacers are not visible (below the line of sight) and, moreover, are sufficiently recessed so that they can receive a sufficient overlay of grout that will maintain coverage over the spacers after use. Additionally, by being recessed below the tile the spacers do not interfere with the jointing material and allows the jointing material to fill more completely from top to bottom. The recessed nature also reduces, if not eliminates, the potential of chipping the tile surface.

According to yet another embodiment, the molding system may also include a coating system, such as an inline coating system, which applies a coating to the tile's decorative side. For example, the coating may be a slip resistant coating. Further, the coating may be applied with a uniform thickness or a variable thickness to overcome any manufacturing defects/inconsistencies, which could level out the tile to ultimately mitigate any tripping hazard to the consumer.

In addition, in some embodiments, because the tile is placed on the concrete mixture rather than the concrete placed on the tile, the tile's orientation can be more accurately maintained so that the final tile product can be within tight tolerances for lateral positioning and as well as tilt—meaning the corners of the tile can be within a tight tolerance from a plane that is parallel to the concrete base.

Accordingly, in some embodiments, when the finished product has a semi-permeable base, the finished product may have a frost-resistant permeable base. This may reduce, if not eliminate, movement after installation. Further, the finished product may have less embodied carbon than regular concrete and may be lighter than concrete as noted. In scenarios where a heavier product may be desirable, the base may be formed with a greater thickness and/or the tile may be increased in thickness. In other embodiments, the process may create a double bonded glue layer because the polymer in the base and the adhesion used to adhere the tile to the concrete base may react to form a stronger bond.

While several forms of the method have been described herein, it should be understood that any of the method steps described in one embodiment or example can be combined with one or more steps from the other method or methods described herein. Further, while mostly described in the context of a ceramic tile, other tiles or tile like elements may be used. For example, porcelain tiles or other decorative tiles or tile-like elements may be used, including man-made tiles, natural stone tiles, clay tiles, or brick, and also non-decorative tiles, for example, which form wear layers. For the purposes of this application “tiles” shall include tiles and tile-like elements.

We claim:

1. A method for manufacturing a landscaping tile product in a molding apparatus, the molding apparatus having a mold cavity, said method comprising the steps of:
filling the mold cavity with a low or zero slump concrete mixture;
providing a tile with a first side and a second side opposed from the first side, the second side forming a decorative side of the tile;
providing an adhesive to improve adhesion between the first side of the tile and the low or zero slump concrete mixture;
positioning the tile on the low or zero slump concrete mixture in the mold cavity with the first side of the tile facing the low or zero slump concrete mixture;
applying pressure and/or vibration to the low or zero slump concrete mixture to densify the concrete mixture before the tile is positioned on the concrete mixture to form a tile and concrete mixture assembly;
applying pressure and/or vibration further includes applying pressure to the tile after positioning the tile on the concrete mixture;
and
after the low or zero slump concrete mixture can hold its own shape, removing the tile and concrete mixture assembly from the mold cavity.

2. The method according to claim 1, further comprising mixing aggregate having an aggregate size in a range of 1 to 15 mm with a cement, water and an additive to form the zero or low slump concrete mixture.

3. The method according to claim 2, further comprising selecting an additive for the porous, zero or low slump concrete mixture, wherein the selecting the additive includes selecting an additive that reacts with the adhesive to form a stronger bond between the tile and the concrete base.

4. The method according to claim 2, wherein the aggregate includes less than 10, 8 or 5% by weight sand.

5. The method according to claim 1, wherein said allowing the concrete mixture to harden includes exposing the tile and concrete mixture assembly to an environment with increased moisture and/or temperature other than ambient air.

6. The method according to claim 1, further comprising providing a mold cavity having a direction of removing the tile and concrete mixture assembly, the mold cavity further including a plurality of grooves extending in the direction of removing, wherein filling the mold cavity includes filling the grooves with the concrete mixture to form one or more spacers on the tile product.

7. The method according to claim 1, wherein said applying pressure and/or vibration includes applying pressure and/or vibration before positioning the tile on the concrete mixture includes applying vibration before positioning the tile on the concrete mixture.

8. The method according to claim 1, wherein said applying pressure and/or vibration after positioning the tile on the concrete mixture further includes applying pressure to the tile after positioning the tile on the concrete mixture with an applied pressure of less than 2 bar.

9. The method according to claim 1, wherein said applying pressure and/or vibration after positioning the tile on the concrete mixture includes applying vibration to the molding apparatus after positioning the tile on the concrete mixture.

10. The method according to claim 1, wherein said applying pressure and/or vibration before positioning the tile on the concrete mixture includes applying vibration to the molding apparatus before positioning the tile on the concrete mixture for a first period of time and said applying vibration to the molding apparatus after positioning the tile on the concrete mixture includes applying vibration to the molding apparatus after positioning the tile on the concrete mixture for a second period of time less than first period of time.

11. The method according to claim 1, after said removing, further comprising allowing the porous, low or zero slump concrete mixture to harden to obtain the landscaping tile product.

12. The method according to claim 1, wherein said providing an adhesive includes applying the adhesive to the first side of the tile before placing the tile in the mold cavity.

13. The method according to claim 1, wherein said applying pressure and/or vibration to the low or zero slump concrete mixture before and after placing the tile on the concrete mixture includes:
before placing the tile on low or zero slump concrete mixture applying (1) pressure to the low or zero slump concrete mixture at a first pressure and (2) vibration to the low or zero slump concrete mixture for a first period of time;
after the step of applying (1) pressure to the low or zero slump concrete mixture at a first pressure and (2) vibration to the low or zero slump concrete mixture for a first period of time, positioning the tile on the low or zero slump concrete mixture in the mold cavity with the first side of the tile facing the concrete mixture to form a tile and concrete mixture assembly; and
after placing the tile on the low or zero slump concrete mixture applying (1) pressure to the tile at a second pressure less than said first pressure and (2) vibration to the molding apparatus after the tile is positioned on the concrete mixture while applying the pressure to the tile for a second period of time less than said first period of time further to densify the concrete mixture.

14. A system for manufacturing a landscaping tile product, the tile product having a tile and a concrete base, said system comprising:
a concrete batch mixing system with a supply of aggregate, a supply of water, a supply of additive, a supply of cement, and a mixer to mix the aggregate, water, cement, and additive to form a low or zero slump concrete mixture;
a molding apparatus including a mold cavity;
a concrete feedbox in communication with said concrete batch mixing system to receive the low or zero slump concrete mixture from said concrete batch mixing system to dispense the low or zero slump concrete mixture into said mold cavity, said concrete feed box being movable across said mold cavity to distribute the low or zero slump concrete mixture across said mold cavity;
a robot with a robotic arm to pick and place a tile in said mold cavity to contact the tile with the concrete mixture after the zero or low slump concrete mixture has been dispensed and distributed into said mold cavity to form a tile and concrete mixture assembly; and
a takeaway conveyor to convey the tile and concrete mixture assembly from said molding apparatus after the tile and concrete mixture assembly has been removed from said molding apparatus.

15. The system according to claim 14, further comprising a control system, said control system including at least one molding apparatus controller to control said molding apparatus and configured to apply pressure to the concrete mixture in said mold cavity prior to placement of the tile on the concrete mixture in said mold cavity.

16. The system according to claim 15, wherein said controller is in communication with said concrete batch mixing system.

17. The system according to claim 15, wherein said concrete batch mixing system includes a controller to control the delivery of the aggregate, water, cement, and additive to said mixer and to control said mixer.

18. The system according to claim 14, further comprising a curing chamber to cure the tile and concrete mixture assembly with an environment having a greater temperature and moisture content that the ambient air outside said curing chamber.

19. The system according to claim 15, further comprising an adhesive dispensing and applicator system to dispense and provide an adhesive to the tile before placement on the concrete mixture in said mold cavity.

20. The system according to claim 19, further comprising an input conveyor to deliver tile to a staging area, said control system further including a system controller in communication with said input conveyor, said molding apparatus controller, and said robot to control timing of the tile being delivered to said staging area and said robot picking and placing a tile in said molding apparatus.
